(19) United States
(12) Patent Application Publication
(10) Pub. No.: US 2010/0236293 A1
(43) Pub. Date: Sep. 23, 2010

(54) APPARATUS AND METHOD FOR MANUFACTURING TAPERED FIBER OPTIC COMPONENTS

(75) Inventor: Eran INBAR, Ramat-Gan (IL)

Correspondence Address: CHOATE, HALL & STEWART LLP, TWO INTERNATIONAL PLACE, BOSTON, MA, 02110, US

(73) Assignee: V-GEN LTD., Ramat-Gan (IL)

(21) Appl. No.: 12/725,914

(22) Filed: Mar. 17, 2010

Related U.S. Application Data
(60) Provisional application No. 61/161,625, filed on Mar. 19, 2009.

(51) Int. Cl. C03B 37/02; C03B 37/01

(52) U.S. Cl. 65/429; 65/435

(57) ABSTRACT

A system for producing a tapered fiber optic component, the system including a support platform, coupled with a first end of an optical fiber, a weight suspended from a second end of the optical fiber, such that the weight applies longitudinal pulling pressure on the optical fiber, and a moveable heater, positioned adjacent to a predetermined area of the optical fiber, the predetermined area is positioned between the first end and the second end of the optical fiber, the moveable heater applying thermal energy to the predetermined area of the optical fiber, when the optical fiber is lengthened by the pulling pressure, the movable heater follows the predetermined area, such that the movable heater remains adjacent to the predetermined area of the optical fiber.

### FIELD OF THE DISCLOSED TECHNIQUE

The disclosed technique relates to fiber-optic components, in general, and to methods and systems for manufacturing a tapered fiber-optic component, in particular.

### BACKGROUND OF THE DISCLOSED TECHNIQUE

Fiber-optic components are widely used in a variety of applications, such as telecommunication and sensors. Tapered fiber-optic components (e.g., tapered optical fibers) are known in the art and are essential components for fiber-optic couplers and fiber-optic sensors. In the following description the terms “fiber-optic component”, “fiber” and “optical fiber” are used interchangeably.

Producing tapered fiber-optic components is achieved by pulling an optical fiber from both ends at opposite directions, while heating a portion of the optical fiber. The heated portion of the optical fiber is lengthened and thinned down until the optical fiber is divided into two separate optical fibers. Each of the separated optical fibers (i.e., the two optical fibers formed by dividing the heated optical fiber), is tapered at the end corresponding to the heated area of the original optical fiber. The tapering shape and length of the optical fibers is determined by the pulling forces and the applied heat characteristics (e.g., magnitude of force, dispersion of heat).

Reference is now made to FIG. 1A, which is a schematic illustration of a system for producing a tapered optical fiber, generally referenced 10, constructed and operative as known in the art. Tapered fiber producing system 10 includes a controller 12, two pulling devices 14, and a heater 16. Controller 12 is coupled with each of pulling devices 14 and with heater 16.

An optical fiber 18 is attached to each of pulling devices 14, such that a segment of fiber 18 is stretched between pulling devices 14. It is noted that, in the case where fiber 18 has a protective polymer coating (i.e., a jacket—not shown), the coating is removed, prior to the operation of system 10, by employing fiber stripping techniques such as mechanical fiber stripping, chemical fiber stripping, thermal fiber stripping, flame fiber stripping, and the like.

Each of pulling devices 14 applies a force on fiber 18, in opposite directions. The forces applied by pulling devices 14 are equal in magnitude and opposite in direction to each other. Heater 16 is located adjacent fiber 18, and applies thermal energy to a predetermined portion of fiber 18 (hereinafter referred to as the heated area, not shown). Controller 12 controls the operation of pulling devices 14 and of heater 16. The characteristics of the forces applied to fiber 18 (e.g., magnitude) and of the thermal energy (e.g., amount of energy, dispersion of energy) determine the resulting tapering of fiber 18. In order to reproduce the tapered fiber, the characteristics of the applied forces and of the thermal energy must be duplicated precisely.

Reference is now made to FIG. 1B, which is a schematic illustration of a system for producing tapered optical fiber, generally referenced 20, constructed and operative as known in the art. Tapered fiber producing system 20 includes a weight 22, a heater 24, and a support platform 26. Weight 22 is coupled with the lower end (not shown) of an optical fiber 28. The upper (not shown) end of optical fiber 28 is coupled with support platform 26. Heater 24 is positioned adjacent to a predetermined portion of fiber 28 (i.e., the heated area—not shown).

Weight 22 applies a pulling force (i.e., by gravity) on fiber 28. Heater 24 applies thermal energy to the heated area of fiber 28. The magnitude of the gravitational force and the characteristics of the applied thermal energy determined the produced tapering of fiber 28. It is noted that, heater 24 is immobile and as fiber 28 is pulled and stretched, the heated area is pulled away from heater 24, such that heater 24 applies thermal energy to varying portions of optical fiber 28, as optical fiber 28 is stretched.

U.S. Pat. No. 6,658,182 issued to Gonthier, and entitled “Temperature Stabilization of Tapered Fiber Optic Components”, is directed to a system for producing tapered fiber optic components. The system includes two fiber holders, a plurality of motorized stages, a heat source, and a controller. Each of the fiber holders is mounted on a motorized stage, such that the fiber holders are able to move towards or away from each other. The heat source is mounted on a motorized stage which enables it to move in all directions. The controller controls the operation of the motorized stages, the fiber holders and the heat source.

A fiber is pulled by both ends in opposite directions by the fiber holders, such that the middle thereof is elongated. The heat source applies heat to the middle of the fiber. The controller determines the distance, velocity and acceleration of the fiber holders. The controller further determines the position of the heat source relative to the fiber and the characteristics of the applied heat. In this manner, the controller determines the characteristics of the tapering.

US Patent Application Publication No. 2008/0022726 to Harper, entitled “Tapered Optical Fibers”, is directed to a system for producing tapered optical fibers. The system includes a heating element, two pulling devices, and a controller. The controller is coupled with the pulling devices and the heating element. The controller controls the pulling devices and the heating element. An optical fiber is coupled between the pulling devices, such that the pulling devices pull the optical fiber in opposite directions. The heating element applies heat to the middle of the optical fiber. The controller determines the tapering of the optical fiber by determining the operation of the pulling devices and of the heating element.

### SUMMARY OF THE PRESENT DISCLOSED TECHNIQUE

It is an object of the disclosed technique to provide a novel method and system for manufacturing tapered fiber-optic components, which overcomes the disadvantages of the prior art. In accordance with an embodiment of the disclosed technique, there is thus provided a system for producing a tapered fiber optic component. The system includes a support platform, a weight, and a moveable heater. The support platform is coupled with a first end of an optical fiber. The weight is suspended from a second end of the optical fiber, such that the weight applies longitudinal pulling pressure on the optical fiber. The moveable heater is positioned adjacent to a predetermined area of the optical fiber. The predetermined area is positioned between the first end and the second end of the optical fiber. The moveable heater is applying thermal energy to the predetermined area of the optical fiber. When the optical fiber is lengthened by the pulling pressure, the movable heater follows the predetermined area, such that the movable heater remains adjacent to the predetermined area of the optical fiber.

In accordance with another embodiment of the disclosed technique, there is thus provided a system for producing a tapered fiber optic component. The system includes a couple of weights, a couple of pulleys, and a heater. Each of the weights is coupled with an opposite end of an optical fiber. Each of the weights is applying longitudinal pressure on the optical fiber. The optical fiber is stretched between the weights across the pulleys. The heater is positioned adjacent a predetermined area of the optical fiber. The heater is applying thermal energy to the predetermined area of the optical fiber. The optical fiber is lengthening and tapering at the predetermined area when the heat is applied.

In accordance with a further embodiment of the disclosed technique, there is thus provided a system for producing a tapered fiber optic component. The system includes a weight, a plurality of pulleys, and a heater. The weight is coupled with both ends of an optical fiber. The weight is applying longitudinal pressure on the optical fiber. The optical fiber is stretched across the pulleys. The heater is positioned adjacent a predetermined area of the optical fiber. The heater is applying thermal energy to the predetermined area of the optical fiber. The optical fiber is lengthening and tapering at the predetermined area when the heat is applied.

### BRIEF DESCRIPTION OF THE DRAWINGS

The disclosed technique will be understood and appreciated more fully from the following detailed description taken in conjunction with the drawings in which:

FIG. 1A is a schematic illustration of a system for producing a tapered optical fiber, constructed and operative as known in the art;

FIG. 1B is a schematic illustration of a system for producing tapered optical fiber, constructed and operative as known in the art;

FIG. 2 is a schematic illustration of a tapered fiber producing system, constructed and operative in accordance with an embodiment of the disclosed technique;

FIG. 3 is a schematic illustration of a tapered fiber-optic component producing system, constructed and operative in accordance with another embodiment of the disclosed technique;

FIG. 4 is a schematic illustration of a tapered fiber-optic component producing system, constructed and operative in accordance with a further embodiment of the disclosed technique; and

FIGS. 5A and 5B are schematic illustrations of tapered fiber-optic components, constructed in accordance with another embodiment of the disclosed technique.

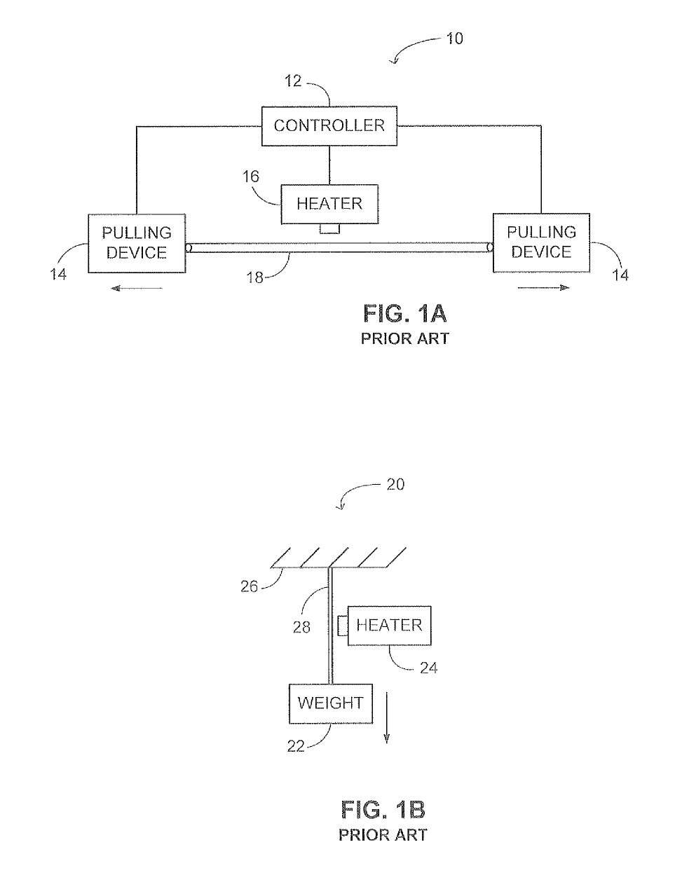

### DETAILED DESCRIPTION OF THE EMBODIMENTS

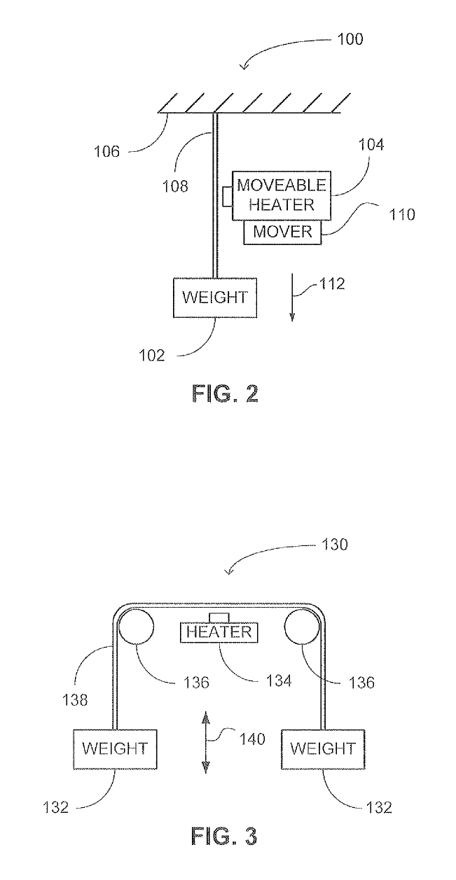

The disclosed technique overcomes the disadvantages of the prior art by applying gravitational longitudinal force on a fiber-optic component, and by applying thermal energy to a specific position of the fiber (i.e., the heated area). Reference is now made to FIG. 2, which is a schematic illustration of a tapered fiber producing system, generally referenced 100, constructed and operative in accordance with an embodiment of the disclosed technique. Tapered fiber producing system 100 includes a weight 102, a moveable heater 104, a support platform 106 and a mover 110. Weight 102 is coupled with the lower end (not shown) of a fiber-optic component 108 (e.g., optical fiber 108). The upper end (not shown) of optical fiber 108 is coupled with support platform 106. Moveable heater 104 is coupled with mover 110. Moveable heater 104 is positioned adjacent a predetermined portion of optical fiber 108 (i.e., the heated area—not shown). It is noted that, in the case where fiber 108 has a protective polymer coating (i.e., a jacket—not shown), the coating is removed, prior to the operation of system 100, by employing fiber stripping techniques such as mechanical fiber stripping, thermal fiber stripping, flame fiber stripping, and the like.

Weight 102 applies gravitational force on optical fiber 108, in the direction of arrow 112. The magnitude of the longitudinal gravitational force is determined by the mass of weight 102. Moveable heater 104 applies thermal energy to the heated area of optical fiber 108. Mover 110 moves Moveable heater 104 along a longitudinal axis, in the direction of arrow 112. Moveable heater 104 can be any heater known in the art such as micro-torch, oven, laser, flame burner, filament fusion heater, ceramic micro heater, electric heater, microwave heater, and the like. The characteristics of the thermal energy applied by moveable heater 104 to the heated area of optical fiber 108 determine the tapering of optical fiber 108. The characteristics of the thermal energy are for example, the amount of thermal energy, the position of moveable heater relative to the heated area (e.g., the distance there-between), the dispersion of the thermal energy, the duration of heating, and the like.

As moveable heater 104 heats optical fiber 108, weight 102 pulls down on fiber 108 and the heated area of optical fiber 108 becomes lengthened and thinned. As fiber 108 lengthens, the heated area thereof moves in the direction of lengthening (i.e., in the direction of weight 102 pulling on the fiber).

Mover 110 moves moveable heater 104, along the longitudinal axis in the direction of lengthening of optical fiber 108 (i.e., the direction of arrow 112), in order to remain adjacent to the heated area. Moveable heater 104 travels half the distance of weight 102, such that it remains adjacent to the heated area (i.e., half the lengthening of optical fiber 108). In other words, moveable heater follows the heated area of optical fiber 108. Mover 110 moves moveable heater 104 manually by a human operator (not shown), mechanically (e.g., a pulley system—not shown), in a motorized manner (e.g., mover 110 is a motor), and the like.

In the example set forth in FIG. 2, fiber-optic component 108 is an optical fiber. Alternatively, fiber-optic component 108 can be any component known in the art. It is noted that the characteristics of the gravitational force applied on optical fiber 108 are easily and precisely reproduced since the mass of weight 102 and the force of gravity are predetermined and constant. The tapering of optical fiber 108 can be reproduced by reproducing the applied force and applied thermal energy.

In the example set forth in FIG. 2, optical fiber 108 is pulled and heated until it is divided into two separate tapered optical fibers (not shown) as detailed herein below with reference to FIG. 5B. Alternatively, system 100 stops pulling and heating fiber 108 before fiber 108 is fully divided (i.e., fiber 108 is thinned), as detailed herein below with reference to FIG. 5A. Weight 102 is further coupled with a stopping element (e.g., a motorized stage—not shown) for supporting weight 102 (i.e., stopping the gravitational force applied on optical fiber 108). In this manner, the stopping element terminates the pulling force applied to fiber 108 before fiber 108 is fully divided.

Reference is now made to FIG. 3, which is a schematic illustration of a tapered fiber-optic component producing system, generally referenced 130, constructed and operative in accordance with another embodiment of the disclosed technique. Tapered fiber-optic component producing system 130 includes a couple of weights 132, a heater 134, and a couple of pulleys 136. An optical fiber 138 is stretched between weights 132, along pulleys 136. Heater 134 is positioned adjacent a predetermined portion of optical fiber 138 (i.e., the heated area—not shown). Heater 134 is substantially similar to moveable heater 104 of FIG. 2.

Weights 132 are identical. Alternatively, if each of weights 132 is different, heater 134 moves in the direction of the heavier weight 132 in order to remain adjacent to the heated area of optical fiber 138. Heater 134 is a moveable heater and can move closer or farther away from the heated area, in the direction of arrow 140. Heater 134 can change the characteristics of the applied thermal energy. The tapering characteristics are determined according to the pulling force (i.e., determined according to the mass of weights 132) and according to the thermal energy characteristics. It is noted that the pulling forces are easily and precisely reproducible, since the mass of weights 132 and the gravitational force are predetermined and constant.

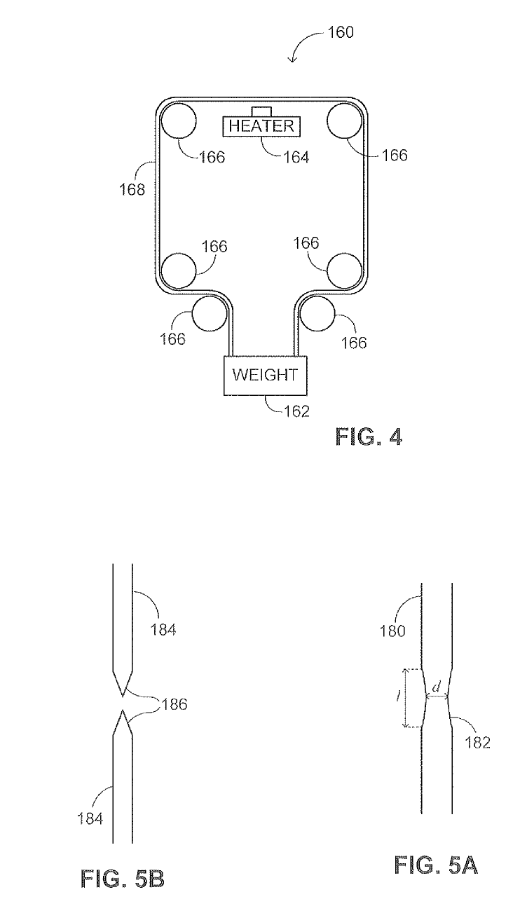

Reference is now made to FIG. 4, which is a schematic illustration of a tapered fiber-optic component producing system, generally referenced 160, constructed and operative in accordance with a further embodiment of the disclosed technique. Tapered fiber-optic component producing system 160 includes a weight 162, a heater 164, and a plurality of pulleys 166. An optical fiber 168 is stretched over pulleys 166 such that both ends of optical fiber 168 are coupled with and pulled by weight 162. Heater 164 is positioned adjacent to a predetermined portion of optical fiber 168 (i.e., the heated area—not shown). Heater 164 is substantially similar to heater 104 of FIG. 2. The heated area of optical fiber 168 remains substantially in the same position since both ends of optical fiber 168 are evenly pulled by weight 132.

Reference is now made to FIGS. 5A and 5B, which are schematic illustrations of tapered fiber-optic components, constructed in accordance with another embodiment of the disclosed technique. With reference to FIG. 5A, optical fiber 180 includes heated area 182 which is lengthened and thinned by employing a tapered fiber-optic component producing system (e.g., system 100, 130 or 160 as described above). The lengthening “l” and thinned thickness “d” of heated area 182 of optical fiber 180 are determined according to the pulling force and the thermal energy, applied to optical fiber 180. The pulling force can be precisely reproduced since it is applied by weights and pulleys. The lengthening and thinning of heated area 182 is achieved by employing and stopping the operation of the tapered fiber-optic component producing system, before optical fiber 180 is divided into two separate tapered optical fibers (e.g., optical fibers 184 of FIG. 5B). Optical fiber 180 is employed for a variety of fiber-optic applications, such as bi-conical couplers, fiber filters, and the like.

With reference to FIG. 5B, two tapered optical fibers 184 are produced by a tapered fiber-optic component producing system. Each of tapered optical fibers 184 includes a tapered end 186. The characteristics of tapered end 186 (e.g., tapered end length or tip angle) are determined by the operational characteristics (e.g., longitudinal pulling force characteristics and thermal energy characteristics) of the tapered fiber-optic component producing system. Each of tapered optical fibers 184 is employed for a variety of fiber-optic applications, such as side-pump couplers, end-pump couplers, and the like.

It will be appreciated by persons skilled in the art that the disclosed technique is not limited to what has been particularly shown and described hereinabove. Rather the scope of the disclosed technique is defined only by the claims, which follow.

1. A system for producing a tapered fiber optic component, the system comprising:
a support platform, coupled with a first end of an optical fiber;
a weight, suspended from a second end of said optical fiber, such that said weight applies longitudinal pulling pressure on said optical fiber; and
a moveable heater, positioned adjacent to a predetermined area of said optical fiber, said predetermined area being positioned between said first end and said second end of said optical fiber, said moveable heater applying thermal energy to said predetermined area of said optical fiber, wherein when said optical fiber is lengthened by said pulling pressure, said movable heater follows said predetermined area, such that said movable heater remains adjacent to said predetermined area of said optical fiber.

2. The system according to claim 1, further comprising a fiber stripper for stripping said optical fiber of a protective coating thereof, at least at said predetermined area of said optical fiber.

3. The system according to claim 2, wherein said fiber stripper is selected from the list consisting of:
a mechanical fiber stripper;
a chemical fiber stripper;
a thermal fiber stripper; and
a flame fiber stripper.

4. The system according to claim 1, further comprising a mover coupled with said movable heater, said mover moving said movable heater, such that said movable heater remains adjacent to said predetermined area of said optical fiber.

5. The system according to claim 1, wherein said mover is selected from the list consisting of:
a manual mover;
an automatic mover;
a mechanical mover; and
a motorized mover.

6. The system according to claim 1, wherein said movable heater is selected from the list consisting of:
a micro-torch;
an oven;
a laser heater;
a flame burner;
a filament fusion heater;
a ceramic micro-heater;
an electric heater; and
a microwave heater.

7. The system according to claim 1, further comprising a stopping element for stopping said pulling force before said optical fiber is fully divided.

8. A system for producing a tapered fiber optic component, the system comprising:
a couple of weights, each of said weights being coupled with an opposite end of an optical fiber, each of said weights applying longitudinal pressure on said optical fiber;
a couple of pulleys, wherein said optical fiber is stretched between said weights across said pulleys; and
a heater, positioned adjacent a predetermined area of said optical fiber, said heater applying thermal energy to said predetermined area of said optical fiber, said optic fiber lengthening and tapering at said predetermined area when said heat is applied.

9. The system according to claim 8, further comprising a fiber stripper for stripping said optical fiber of a protective coating thereof, at least at said predetermined area of said optical fiber.

10. The system according to claim 9, wherein said fiber stripper is selected from the list consisting of:
a mechanical fiber stripper;
a chemical fiber stripper;
a thermal fiber stripper; and
a flame fiber stripper.

11. The system according to claim 8, wherein said movable heater is selected from the list consisting of:
a micro-torch;
an oven;
a laser heater;
a flame burner;
a filament fusion heater;
a ceramic micro-heater;
an electric heater; and
a microwave heater.

12. The system according to claim 8, further comprising a stopping element for stopping said pulling force before said optical fiber is fully divided.

13. A system for producing a tapered fiber optic component, the system comprising:
a weight, said weight being coupled with both ends of an optical fiber, said weight applying longitudinal pressure on said optical fiber;
a plurality of pulleys, said optical fiber being stretched across said pulleys; and
a heater, positioned adjacent a predetermined area of said optical fiber, said heater applying thermal energy to said predetermined area of said optical fiber, said optic fiber lengthening and tapering at said predetermined area when said heat is applied.

14. The system according to claim 13, further comprising a fiber stripper for stripping said optical fiber of a protective coating thereof, at least at said predetermined area of said optical fiber.

15. The system according to claim 14, wherein said fiber stripper is selected from the list consisting of:
a mechanical fiber stripper;
a chemical fiber stripper;
a thermal fiber stripper; and
a flame fiber stripper.

16. The system according to claim 13, wherein said movable heater is selected from the list consisting of:
a micro-torch;
an oven;
a laser heater;
a flame burner;
a filament fusion heater;
a ceramic micro-heater;
an electric heater; and
a microwave heater.

17. The system according to claim 13, further comprising a stopping element for stopping said pulling force before said optical fiber is fully divided.
